(19) United States
(12) Patent Application Publication
(10) Pub. No.: US 2017/0113913 A1
(43) Pub. Date: Apr. 27, 2017

(54) BEVERAGE DISPENSING SYSTEM AND METHOD

(71) Applicant: Cornelius, Inc., St. Paul, MN (US)

(72) Inventors: Vincenzo DiFatta, Wood Dale, IL (US); Michal Augustyniak, Bloomingdale, IL (US)

(73) Assignee: Cornelius, Inc., St. Paul, MN (US)

(21) Appl. No.: 15/094,197

(22) Filed: Apr. 8, 2016

Related U.S. Application Data
(60) Provisional application No. 62/246,181, filed on Oct. 26, 2015.

(51) Int. Cl. B67D 1/08; G06F 3/0482; G06F 3/16; B67D 1/00; H04R 1/02

(52) U.S. Cl. CPC B67D 1/0888; B67D 1/0877; B67D 1/0021; B67D 1/0004; H04R 1/028; G06F 3/167; G06F 3/0482; H04R 2499/15; H04R 2400/03

(57) ABSTRACT

A beverage dispensing system comprises a user interface system having a digital display, the user interface system configured to receive a beverage selection from a user, and a beverage dispenser having a plurality of beverage sources, the beverage dispenser operable to control a flow of beverage from one or more of the beverage sources in accordance with the beverage selection. A surface electroacoustic transducer is attached to a portion of the digital display or the beverage dispenser that, in response to receiving the beverage selection, conducts vibration into the portion of the digital display or the beverage dispenser to produce a sound from that portion.

### CROSS-REFERENCE TO RELATED APPLICATION

The present application is based on and claims priority to U.S. Provisional Patent Application Ser. No. 62/246,181 filed Oct. 26, 2015, the disclosure of which is incorporated herein by reference.

### FIELD

The present disclosure relates to beverage dispensing. More specifically, the present disclosure relates to beverage dispensing systems and methods controllable by a user and having a user interface that plays a sound audible to the user.

### BACKGROUND

The following patents are incorporated herein by reference in entirety.

U.S. Pat. No. 3,636,281 discloses an electroacoustic transducer including a drive coil mounted within the airgap of an annular permanent magnet. The drive coil is connected to the transducer case which in turn is attached to a suitable support structure such as a wall or ceiling. Electrical signals within the drive coil cause it to move, and this vibration is transmitted to the support structure which then acts as a sounding surface for the transducer.

U.S. Pat. No. 6,058,986 discloses an electronic control for an automatic filling beverage dispensing valve. The dispensing valve includes a valve body, a flow control mechanism and a solenoid. The valve further includes an electrically conductive cup actuated lever for operating a micro-switch that is operatively connected to the electronic control of the present invention. The valve body includes a nozzle and a stainless steel electrical contact for providing electrical connection between the electronic control and the beverage as it flows through the nozzle into a cup. The electronic control of the present invention is microprocessor controlled and includes an internal signal generator which generates a signal independent of the input line frequency supplying the power to the control. This generated signal is buffered and applied to the dispensing cup lever while simultaneously being applied to a reference input of a phase-locked loop detector circuit. When beverage fills a cup to the rim thereof the beverage can flow over the rim and thereby provide an electrical continuity between the electrically conductive lever and the stainless steel contact within the nozzle. Thus, a signal is conducted to an input of the phase locked-loop detector circuit where that electrical signal is compared to the generated reference signal. If the two signals are matched in both frequency and phase, the detector circuit generates a continuity detected signal to the micro-processor. The microprocessor thereby ends dispensing by de-energizing the solenoid.

U.S. Patent Application Publication No. 2008/0073376 discloses a dispenser, for preferably Frozen Carbonate Beverage (FCB) product, having valves that can be manually or electrically operated in response to electronic controls. The valve has a jam dispensing position, and can be used with an additive, such as flavors, injector. A power failure back up is provided to close the valve, along with sanitation and optional purging cycles. Product dispense is provided only when sensed to have a desired consistency and/or in a condition to prevent splashing. Additive dispense is provided only when product is present. The dispenser can have a monitor and suitable controller to dispense strips or layers of different additives or flavors into the product.

U.S. Patent Application Publication No. 2011/0220689 discloses an ice dispense system for an ice dispenser characterized by a chute having an ice receiving upper end in communication with an ice bin outlet passage and an ice dispensing lower end. Beginning with the chute filled with ice and its lower end closed, to dispense a selected quantity of ice, the chute lower end is opened for one of a plurality of different time periods, where each individual time period of the plurality is of a duration to dispense from the chute an associated predetermined quantity of ice. In response to dispensing ice from the chute, an agitator in the bin is operated for one of a plurality of different time periods, where each individual time period of the plurality is of a duration to move through the bin outlet passage and into the upper end of the chute an amount of ice substantially equal to that dispensed. The ice dispensing system is provided with an improved user interface and user programmable features.

U.S. Pat. No. 9,107,449 discloses an apparatus and method for creating carbonated beverages having a customizable carbonation level. The invention uses a CPU to control an inlet valve which connects a tank of pressurized carbon dioxide to a vessel containing the beverage to be carbonized. The tube connecting the tank of pressurized carbon dioxide to the vessel contains an orifice for reducing the carbon dioxide's flow rate, thereby increasing control over the amount of carbon dioxide introduced to the vessel. A motor agitates the vessel, causing the carbon dioxide to become absorbed in the beverage. During the pressurization process, the pressure inside the vessel is monitored by the CPU to determine whether more CO2 should be added to the vessel. An outlet valve causes excess pressure to drain from the vessel. An outlet orifice causes the pressure to release gradually, thus preventing the beverage from foaming.

U.S. Patent Application Publication No. 2015/0355810 discloses systems and method for beverage dispense from a plurality of users include a beverage dispenser with a touch-sensitive graphical display. A computer of the beverage dispenser receives touch event data points and identifies one or more GUI sections of a plurality of GUI sections associated with the received touch event data points. The computer further operates to interpret a touch event input and provide a command responsive to the input to an associated dispensing unit.

### SUMMARY

In one embodiment, a beverage dispensing system comprises a user interface system having a digital display, the user interface system configured to receive a beverage selection from a user, and a beverage dispenser having a plurality of beverage sources, the beverage dispenser operable to control a flow of beverage from one or more of the beverage sources in accordance with the beverage selection. A surface electroacoustic transducer is attached to a portion of the digital display or the beverage dispenser that, in response to receiving the beverage selection, conducts vibration into the portion of the digital display or the beverage dispenser to produce a sound from that portion.

One embodiment of a user interface system for a beverage dispensing system includes a digital display that displays one or more beverage options, the display having a front. The user interface system further includes a user input receiver for receiving user input of a beverage selection, and a surface electroacoustic transducer attached to a portion of the digital display that, in response to receiving the beverage selection, conducts vibrations into the portion of the digital display to produce a sound from the portion.

In one embodiment, a method of dispensing a beverage includes receiving a beverage selection at a user interface system that includes digital display, the digital display having a front, and then operating a surface electroacoustic transducer attached to the front of the digital display to conduct vibrations into the front of the digital display to produce a sound from the front of the digital display in response to receiving the beverage selection. A beverage component is then dispensed from one or more beverage sources in accordance with the beverage selection.

### BRIEF DESCRIPTION OF THE DRAWINGS

Examples are described with reference to the following drawing figures. These same numbers are used throughout the figures to reference like features and components.

FIG. 1 is a schematic depiction of an exemplary embodiment of a beverage dispenser with a user interface system including a digital display.

FIG. 2 is a schematic depiction of an exemplary computing system for a beverage dispensing system.

FIG. 3 is a schematic depiction of another embodiment of a beverage dispenser having a user interface system including a digital display.

FIG. 4 depicts an exemplary embodiment of a user interface display for a beverage dispenser.

FIG. 5 depicts another exemplary embodiment of a user interface system for a beverage dispenser.

FIG. 6 is a flow chart depicting one embodiment of a method of dispensing a beverage.

FIG. 7 is a flow chart depicting another embodiment of a method of dispensing a beverage.

### DETAILED DESCRIPTION

The present inventors have endeavored to provide an improved user interface system for a beverage dispenser. The user interface system allows and enables a user to select, among other things, a beverage size and/or the content of the beverage, such as a brand and/or size of fountain beverage. The improved user interface system produces a sound without incorporating a typical audio speaker component that is susceptible to damage via fluid ingress, contamination, or vandalism. For example, typical audio speakers include a voice coil connected to a diaphragm, or cone. The susceptibility of systems incorporating these typical audio speakers stems from the openings required to allow sound produced by the cone to exit the unit. Typically, speakers are placed behind openings in a housing of the user interface system, such as one speaker opening on each side.

Through their experimentation and research in the relevant field, the present inventors have recognized that openings in the user interface system or user interface elements of the beverage dispenser allows for liquid intrusion that may damage the device or element. Further, such openings provide a potential location for a build up of mold or bacteria, which are highly undesirable and can produce a safety hazard for food and beverage dispensing. Moreover, these openings provide opportunities for foreign objects to enter the area of the speaker and cause damage, such as by puncturing the speaker diaphragm.

Moreover, through their experimentation and research the inventors recognized that while placing the speaker openings on the side of the machine moves the speakers away from the beverage dispensing area, and thus out of the “splash zone,” moving the speakers to the side reduces the audio quality and requires a louder volume because the sound travels out of the sides of the machine and away from the user, rather than towards the user. This arrangement is less than ideal and does not produce an immersive, targeted audio experience for the user.

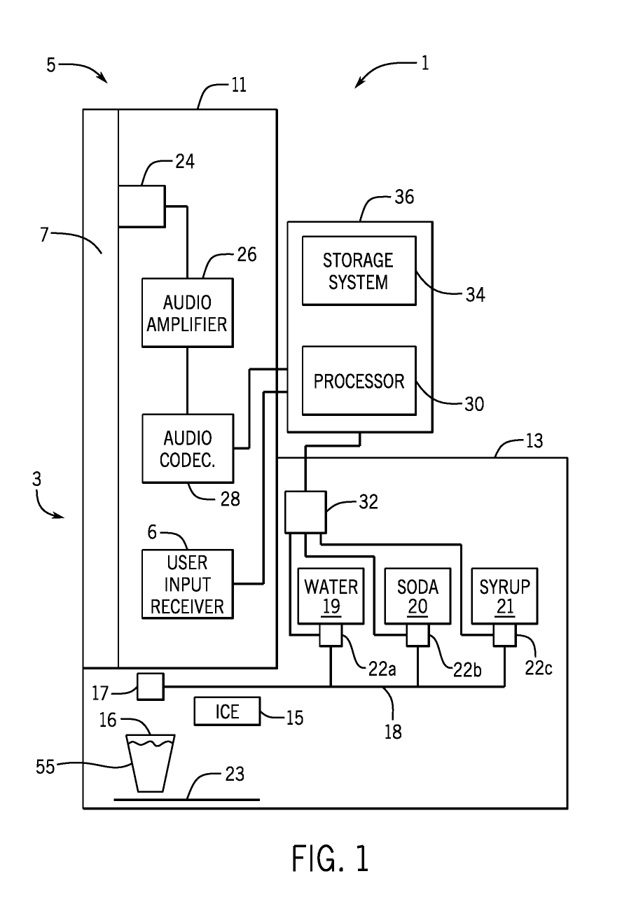

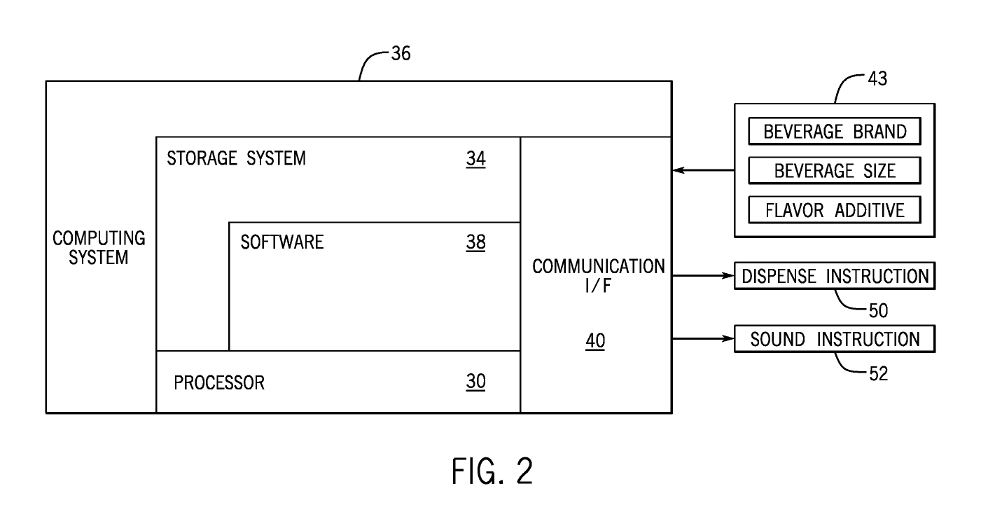

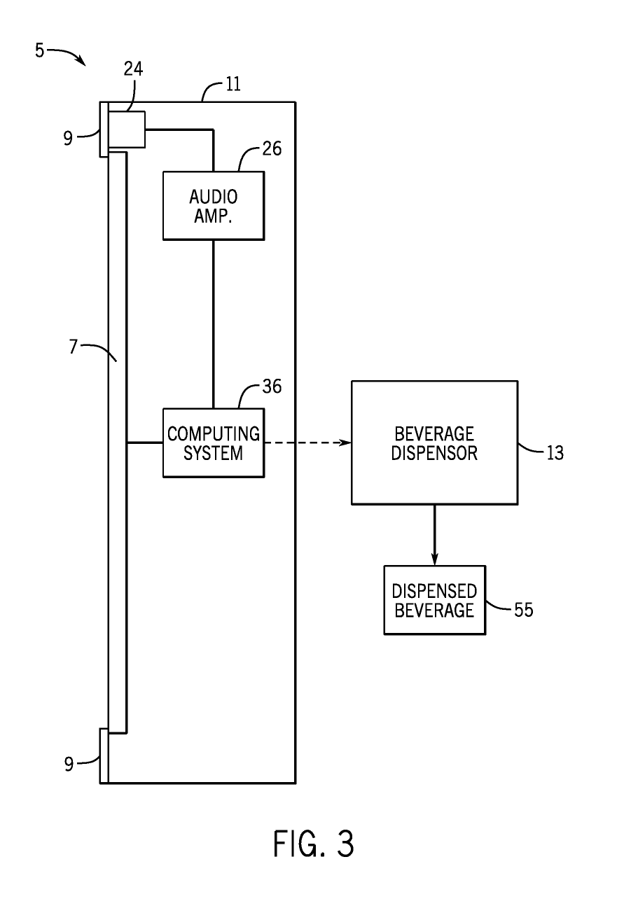

The present inventors have developed the disclosed system and method in order to overcome the aforementioned problems and challenges with currently available beverage dispensing systems. In the embodiment schematically depicted in FIGS. 1 and 2, the beverage dispensing system 1 includes a user interface system 3, a beverage dispenser 13, and a computing system 36. The user interface system 3, including digital display 5, operates to receive a beverage selection 43 from a user. For example, the beverage selection 43 may include a beverage brand, size, a flavor additive, etc. The beverage selection 43 is received and processed by the processor 30 in computing system 36, which then sends a dispense instruction 50 to controller 32 in the beverage dispenser 13 to dispense a beverage in accordance with the beverage selection 43. The processor 30 sends sound instruction 52 to cause the surface electroacoustic transducer 24, which is attached to a portion of the digital display 5 or the beverage dispenser 13, to produce a vibration that generates a sound. In the exemplary embodiments, the sound instruction 52 may be communicated to an audio codec 28 or directly to an audio amplifier 26 (FIG. 3).

A person having ordinary skill in the relevant art will understand in light of this disclosure that the surface electroacoustic transducer 24 is a class of devices that may be mounted to a suitable structure in order to cause that structure to serve as a sounding surface by causing that surface to vibrate and emanate a desired sound. The surface electroacoustic transducer 24 has a coil assembly, which includes a voice coil comprised of wire windings that is attached to a magnet body. The coil assembly transforms electrical signals into sound vibrations. The coil assembly is attached to a plate, and the plate is attachable to a surface in order to transfer the vibrations into that surface and thereby cause that surface to be a sound emitter. An exemplary surface electroacoustic transducer 24 is part number COM-10975 by SparkFun Electronics of Niwot, Colo. Another exemplary surface electroacoustic transducer 24 is the sound surface transducer by Recon Electronics CO LTD of Hong Kong, China.

The beverage dispenser 13 has a plurality of beverage sources 19-21 containing beverage components, including the exemplary water source 19, soda source 20, and syrup source 21. The beverage sources 19, 20, 21 in the embodiment of FIG. 1 include beverage components which are combined into a dispensed beverage 55 comprising at least one diluent, such as water or soda (carbonated water), and at least one flavoring, such as a flavored syrup. The flow of beverage from each beverage source 19-21 is controlled by at least one flow valve 22a-22c operatively connected to the respective beverage source 19-21. The output of each flow valve 22a-22c feeds into a tubing 18, where the plurality of beverage components are combined. The tubing 18 connects to nozzle 17, which dispenses the beverage into container 16, which may exemplarily be a cup, in order to produce the dispensed beverage 55 in accordance with the beverage selection 43 made by the user. In an alternative embodiment, the beverage dispenser 13 may be comprised of beverage sources having premixed beverage products therein, and thus may only require dispensing from one beverage source during any given session. Additionally, the beverage dispenser 13 may include an ice dispenser 15 to store and dispense ice into the beverage container 16. The beverage container 16 may be supported on platform 23 during the dispensing and, in one embodiment, is made available to the user once the dispensed beverage 55 is complete.

The beverage dispensing system 1 may include a controller 32 operatively connected to the flow valves 22a-22c for each beverage source 19-21 to control the flow of beverage therefrom. In the depicted embodiment of FIG. 1, the controller 32 is located in the beverage dispenser 13. In other embodiments, the controller 32 may be located elsewhere, such as in the computing system 36. In the depicted embodiment, the controller 32 is communicatively connected to the computing system 36, such that dispense instruction 50 can be sent from the processor 30 to the controller 32 on what beverage to dispense. The controller 32 may then direct the dispensing of beverage components from beverage sources 19-21 by controlling valves 22a-22c in accordance with the beverage selection 43. For example, the computing system 36 may contain software 38 that gets executed by the processor 30 to receive and compile the beverage selection 43 and determine the proper operation of the flow valve 22a-22c to dispense that beverage selection 43. The valve 22a-22c operation is then communicated to and executed by the controller 32. In other embodiments, the dispense instruction 50 may contain the beverage selection 43, and the controller 32 may be configured to retrieve and execute instructions to operate valves 22a-22c accordingly.

The surface electroacoustic transducer 24 may be attached to any portion of the digital display 5 or the beverage dispenser 13 that is sufficiently hard to conduct the vibrations from the surface electroacoustic transducer 24—e.g., glass, metal, wood, or any hard plastic, such as Delron, Nylon, etc. For example, the surface electroacoustic transducer 24 may be attached to a front 7 of the digital display 5, such as in the embodiment depicted in FIG. 1. A person having ordinary skill in the art will understand, in light of this disclosure, that the digital display 5 schematically depicted in FIGS. 1 and 3 may be any device capable of accepting a digital signal and producing a visual image therefrom, and that numerous such devices are known and available. The front 7 of the digital display 5 may be made of glass or a hard plastic material commonly employed in standard digital display units.

As shown in FIG. 2, the surface electroacoustic transducer 24 may be rigidly attached to an inside, top portion of the front 7. In such an embodiment, the front 7 of the digital display 5 conducts vibrations from the surface electroacoustic transducer 24 to become a sounding surface, to produce sound waves from the front 7, itself. In such an embodiment, the sound emanates toward the user standing in front of the digital display 5. In another embodiment, the surface electroacoustic transducer 24 may be attached to a metal or plastic element inside the digital display 5. FIG. 3 depicts an embodiment where the surface electroacoustic transducer 24 is attached to a frame 9 surrounding the front 7, which may be, for example, made of metal. In such an embodiment, the surface electroacoustic transducer 24 conducts vibrations into the frame 9 in order to cause the frame 9 to produce the sound. Depending on the connection between the frame 9 and the front 7, the vibrations may be conducted from the frame 9 into the front 7 such that the sound is produced from both the frame 9 and the front 7. In still other embodiments, the electroacoustic transducer 24 may be connected to the housing 11 of the digital display 5 such that the sound is produced from the housing 11, and potentially from other elements rigidly connected to the housing 11. In still other embodiments, the electroacoustic transducer 24 may be connected to a portion of the beverage dispenser 13. For example, the electroacoustic transducer 24 may be connected to ice dispenser 15 within the beverage dispenser 13. The ice dispenser 15 is a hollow, hard-surfaced body, and thus it may provide an excellent sound producer and amplifier. In still other embodiments, the electroacoustic transducer may be attached to another portion of the drink dispenser 13 comprised of hard material, such as glass, metal, or hard plastic, or may be attached to some portion of the installation elements surrounding or encasing the drink dispensing system 1 (e.g., cabinetry or the like).

The electroacoustic transducer 24 may be connected to the portion of the digital display 5 or the beverage dispenser 13 by any means. For efficiency and effectiveness of vibration transfer, it may be desirable to provide a rigid connection between the surface electroacoustic transducer 24 and the relevant portion of the digital display 5 or beverage dispenser 13. For example, the surface electroacoustic transducer 24 may be fixed to the front 7 or frame 9 of the digital display 5 using a glue, an epoxy, or a polyester resin. In another embodiment, the surface electroacoustic transducer 24 may be connected to the relevant portion using a bolt or latch connection. In other embodiments, the surface electroacoustic transducer 24 may be connected to the relevant portion of the digital display 5 or beverage dispenser 13 by any known connection means, including softer and more flexible connection means, such as double-sided tape.

By attaching the surface electroacoustic transducer 24 to a portion of the digital display 5 or the beverage dispenser 13, the beverage dispensing system 1 and method 60 developed by the present inventors solves the problems described above encountered with systems and methods employing traditional speakers requiring openings in the display panel for sound projection. Importantly, the presently disclosed user interface system 3 for the beverage dispensing system 1 and method 60 eliminate the need for any sound openings, thereby preventing the possibility of fluid ingress and eliminating the possibility of damage or puncture to the speaker device due to objects penetrating the sound openings. Further, the lack of openings avoids the possibility of mold or bacteria build up and provides a surface that can be cleaned with no possibility of fluid ingress. Moreover, in embodiments where the surface electroacoustic transducer 24 causes sound to emanate from the surface of the front 7 of the digital display 5, such as embodiments where the surface electroacoustic transducer 24 is connected to the front 7 or the frame 9, sound is directed toward the user, providing an excellent audio experience for the user.

The sound may be used to provide information to the user and/or to provide user entertainment. For example, the sound may confirm the beverage size and/or the beverage brand of the beverage selection 43. For example, the sound may state the beverage brand once the user has inputted the beverage selection 43. Likewise, the sound may state the size of the inputted beverage selection 43, or may state both the size and brand selected by the user—e.g., stating “large Diet Coke” or “16 oz Sprite” Likewise, the sound may correspond with the brand of the beverage selection 43, such as a jingle or a short slogan for the beverage brand. Alternatively or additionally, the sound may provide an instruction to the user, such as how to use the beverage dispenser, how to input a beverage selection 43, or where or when to retrieve the dispensed beverage 55. In still other embodiments, the sound may be an advertisement, which may correspond to a video advertisement played on the digital display 5.

In one embodiment, the sound is produced while the beverage selection 43 is in the process of being fulfilled. For example, the sound may play longer when dispensing a large beverage versus a small beverage because a large beverage may take longer to dispense than a small beverage. For example, the computing system 36, and specifically a storage system 34 thereof, may store a fill duration for each beverage size and may play the sound for the fill duration corresponding to the size of the beverage selection 43. In still other embodiments, the sound generation may be controlled in conjunction with one or more of the valves 22, such that the sound is played while the valve(s) are open and thus a beverage is being dispensed. Likewise, the sound may provide confirmation to a user that the system 1 has received a user input, such as a touch or gesture input to the digital display 5 to scroll through the beverage choices, select a beverage size or brand, add a flavor additive (e.g., cherry, vanilla, lemon, etc.), etc.

As shown in the embodiments of FIGS. 1 and 3, the digital display 5 includes a surface electroacoustic transducer 24 attached to some portion of the digital display 5. As described above, other embodiments may have the electroacoustic transducer 24 in the beverage dispenser 13, such as attached to the ice dispenser 15, which may be in addition to or in place of having an electroacoustic transducer 24 in the digital display 5. In the depicted embodiments, each electroacoustic transducer 24 is attached to an audio amplifier 26, which receives an audio signal from an audio codec 28. The audio codec 28 is controlled by the processor 30 of computing system 36. The audio codec 28 is a device or computer program that codes and decodes a digital data stream of audio. Accordingly, the processor 30 may produce a digital data stream representing an audio output, and the audio codec 28 may decode the digital data stream into an analog audio stream, which is then amplified by the audio amplifier 26. The electrical audio signal is then transformed into vibrations by the surface electroacoustic transducer 24. The connection between the audio codec 28 and the audio amplifier 26 may be a physical, wired connection, or it may be a wireless connection, such as via a Bluetooth standard communication protocol. The audio codec 28 may be, for example, a Low Complexity Subband Coding (SBC), which is an audio subband codec specified by the Bluetooth Special Interest Group for the Advanced Audio Distribution Profile (A2DP). SBC is a digital audio encoder and decoder used to transfer data to audio output devices and supports mono and stereo streams.

The beverage dispensing system 1 further includes computing system 36. In FIG. 1, computing system 36 is a separate element from the digital display 5 and the beverage dispenser 13; however, a person having ordinary skill in the relevant art will understand in light of this disclosure that the computing system 36, and the elements thereof, may be integrated into either of the digital display 5 or the beverage dispenser 13. As shown in FIG. 2, the computing system 36 includes processor 30 and storage system 34. For example, the storage system 34 may store data and software retrieved and executed by the processor 30. Processor 30 accesses a communication interface 40 for interfacing with other devices in the system, such as the audio codec 28, the user input receiver 6, and the controller 32. It will be understood by a person having ordinary skill in the relevant art that in various other embodiments the computing system 36 may incorporate various elements that are shown separately in the embodiments of FIGS. 1 and 2, such as the audio codec 28, the user input receiver 6 and/or the controller 32. For example, FIG. 3 depicts an embodiment wherein the computing system 36 receives user input signals, which may be in any of various formats described below, and generates output instructing the beverage dispenser 13 to dispense a beverage in accordance with the beverage selection 43. The computing system 36 may incorporate the function of the controller 32 described above, and thus may control the flow valves 22a-22c of the beverage sources 19-21 in order to dispense the beverage selection 43.

In order to perform the functions and method steps described herein, the processor 30 loads and executes software 38 from the storage system 34, which may include one or more applications comprising computer-readable instructions that, when executed by the processor 30 (and/or audio codec 28, and/or controller 32) direct the operations described herein. It should be understood that such computer-readable instructions may be contained in a single software element having one or more modules, or may be distributed over several software elements, or applications. Similarly, while the description as provided herein refers to a single computing system 36 and processor 30, it is recognized that implementations of the beverage dispensing system 1 can be performed using one or more processors, which may be communicatively connected, and that such implementations are considered to be within the scope of this description. The processor 30 may be one or more microprocessors and other circuitry that receives and executes software from storage system 34. The processor 30 may be implemented with a single processing device, or may be distributed across multiple processing devices or sub-systems that cooperate in executing program instructions. Examples of processor 30 include a general purpose central processing unit, an application-specific processor, and/or logic devices, as well as any other type of processing device, combinations of processing devices, or variations thereof.

The storage system 34 may comprise any storage media, or group of storage media, readable by the processor 30, and capable of storing software. The storage system 34 can include volatile and non-volatile memory, removable and non-removable media implemented in any method or technology for storage information, such as computer-readable instructions, data structures, program modules, or other data. The storage system 34 may be implemented as a single storage device, but may also be implemented across multiple storage devices or sub-systems, which may be accessible to the processor 30. The storage system 34 may further include additional elements, such as a controller capable of communicating with the processor 30. Examples of storage media include random access memory, read only memory, magnetic disks, optical disks, flash memory, virtual memory, non-virtual memory, magnetic sets, magnetic tape, magnetic disk storage or other magnetic storage devices, or any other medium which can be used to store the desired information and that may be accessed by a processor 30, as well as any combination or variation thereof, or any other type of storage medium. In some implementations, the storage media may be non-transitory storage media. In some implementations, at least a portion of the storage media may be transitory.

The user interface system 3 includes the digital display 5 and is configured to receive input from a user in order to select a beverage—i.e. input the beverage selection. The user interface system 3 is also configured to play a sound from a portion of the digital display 5 and/or the beverage dispenser 13, as is described above. The user interface system 3 includes user input receiver 6, which in the embodiment of FIG. 1 is housed within the housing 11 of the digital display 5. The user input receiver 6 may be configured to receive any of various forms of input from a user, and thus may include, for example, a voice detection device, a touch input detection device for receiving a touch gesture from the user (such as on the front 7 of the digital display 5), a motion input detection device for detecting non-touch gestures and other motions by the user, a mouse, a keyboard, a button or switch (such as one or more membrane switches) and/or other comparable input devices and associated processing elements capable of receiving such input from a user. For example, the user input receiver 6 may include a microphone to receive a voice input from the user. Alternatively or additionally, the user input receiver 6 may include a touchscreen input device, which may be incorporated into the front 7 of the digital display 5, which may incorporate a touchscreen sensor and accompanying controller-based firmware. In some embodiments, the user input receiver 6 may further include software for interpreting the received user input. In other embodiments, the software for processing the user input via the user input receiver 6 is provided in the computing system 36. In certain embodiments, the user input receiver 6 may include a motion capture device for detecting gestures from the user, such as one or more cameras or gesture sensing devices adaptable for detection of certain gesture inputs. Examples of such motion capture devices are the APDS-9960 Proximity and Gesture Sensor by Avago Technologies, the Si114x Ultraviolet Index, Gesture, Proximity and Ambient Light Sensor by Silicon Labs, or other motion sensor recognized by a person of ordinary skill in the art as appropriate in view of the present disclosure.

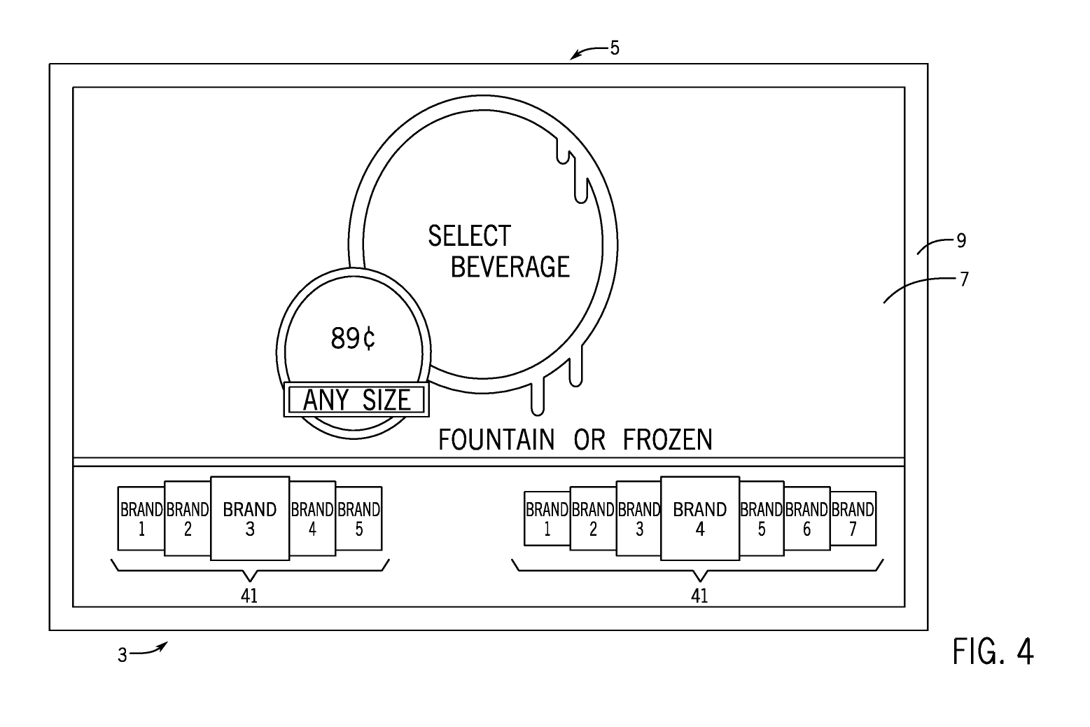

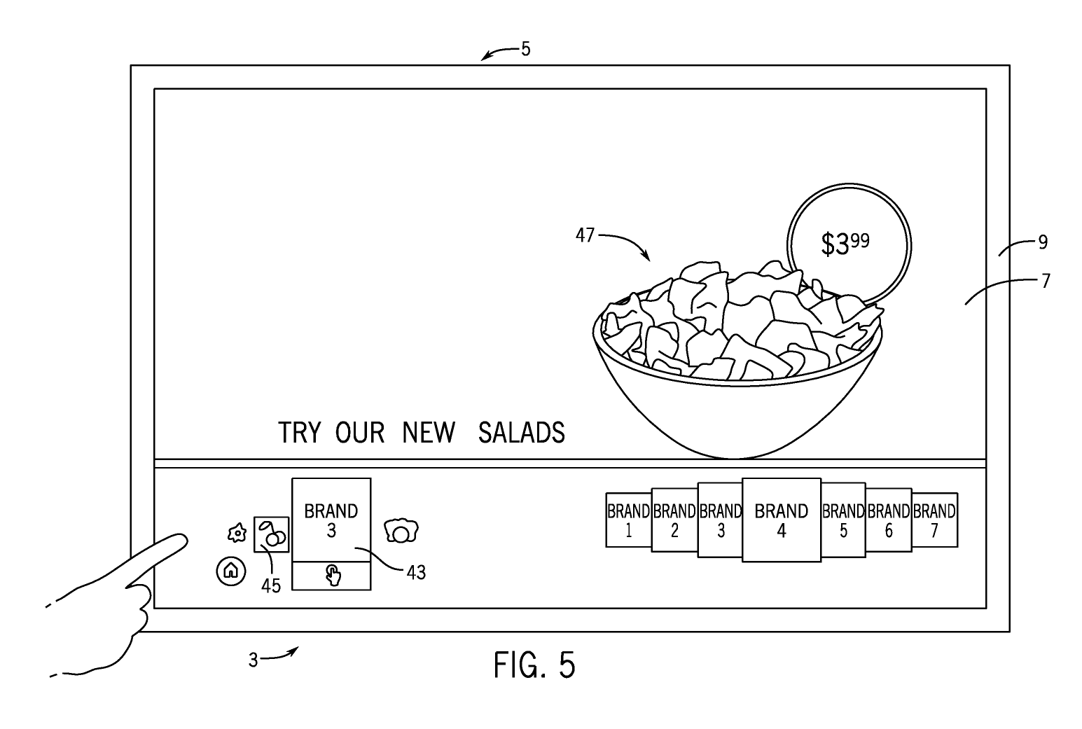

The user interface system 3 further includes graphical displays on the display device 5, such as those depicted in FIGS. 4 and 5. In FIG. 4, the digital display 5 presents graphical displays representing beverage options 41 allowing a user to select a beverage brand, such as Coca-Cola®, Diet Coke®, Sprite®, Pepsi®, etc. Furthermore, the beverage options 41 may include non-brand options, such as water, soda, etc. For example, the user interface system 3 may allow a user to scroll through the graphical displays representing beverage options 41, such as by touching or swiping the relevant portion or surface of the front 7 of the digital display 5. For example, the user may swipe from right to left on the front 7 near the beverage options 41 in order to scroll rightwards through the beverage options 41. Likewise, the user may swipe from left to right in order to scroll left through the graphical displays representing beverage options 41. In an alternative embodiment, the user may select from the graphical displays representing beverage options 41 by using gesture input or verbal commands to the user interface system 3, as is described above. The user interface system 3 may also provide graphical displays representing beverage options 41 related to beverage size, such as small, medium, large, etc. The graphical displays representing beverage options 41 may further include type, or format, options, such as frozen, fountain, with ice, or without ice.

FIG. 5 presents another embodiment of user interface system 3 where the digital display 5 presents a graphical display in the form of a video advertisement 47. In the depicted embodiment, the sound emanating from the digital display 5 and/or the beverage dispenser 13 may correspond with the video advertisement 47. Additionally, the sound may confirm the beverage size and/or the beverage brand of the beverage selection 43. The beverage dispensing system 1 may be configured to allow the addition of flavor additives (e.g., cherry, vanilla, lemon), and in such an embodiment the user interface system 3 may present graphical displays representing flavor additive options 45. The sound emanating from the digital display 5 and/or the beverage dispenser 13 may further confirm any flavor additive option 45 selected, and/or may provide a user with instructions regarding the selection of a beverage and/or flavor additive.

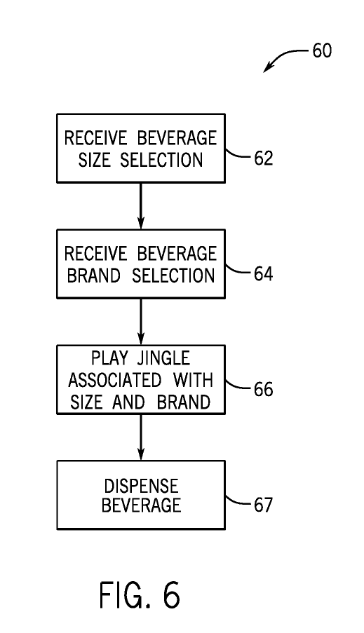

FIG. 6 depicts one embodiment of a method 60 of dispensing a beverage. At step 62 a beverage size selection is received, such as by the user input receiver 6 and the processor 30. Likewise, a beverage brand selection is received at step 64. Alternatively or additionally, a beverage type selection may be received in a similar fashion, such as selecting water or soda, or selecting a delivery format, such as frozen or a fountain beverage. A sound is played at step 66 in response to receiving the beverage selection items at steps 62 and 64, where a surface electroacoustic transducer 24 conducts vibration into a portion of the digital display 5 and/or the beverage dispenser 13 to produce a sound as is described above. In one embodiment, the sound may be a jingle associated with the beverage brand selected at step 64. The jingle may also be associated with the size selection made at step 62. For example, a longer jingle may be played when a larger beverage is selected, because it may take longer to dispense the larger beverage. As described above, the selected jingle may be chosen and timed such that the jingle plays while the beverage is being dispensed, and stops once the beverage dispensing process is completed. At step 67, the beverage is dispensed, such as while the jingle is playing.

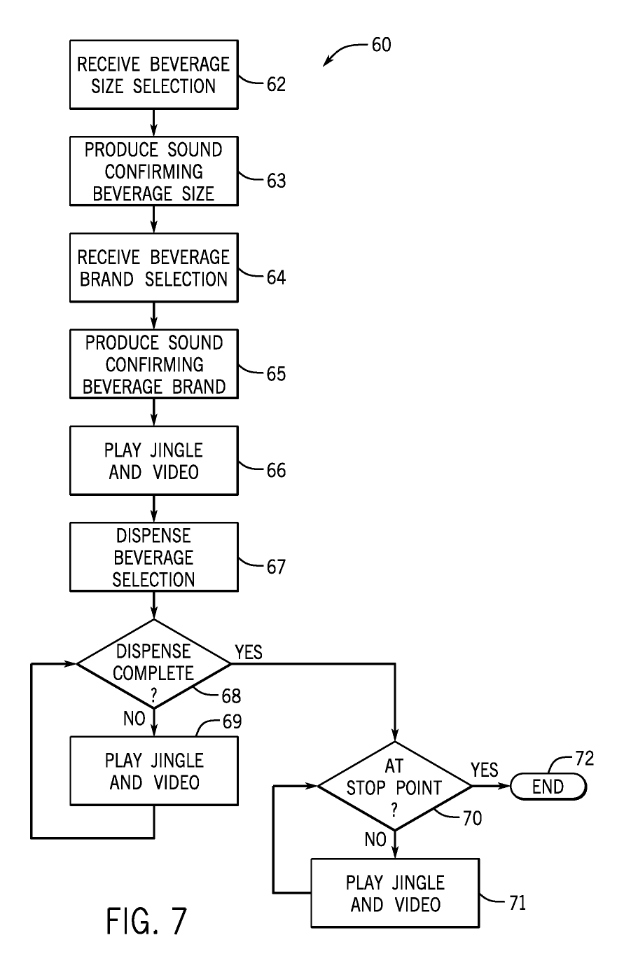

FIG. 7 depicts another embodiment of a method 60 of dispensing a beverage. A beverage size selection is received at step 62, and then a sound is produced at step 63 according to the method and system described herein to confirm the beverage size selected at step 62. At step 64 a beverage brand selection is received, and then a sound is produced at step 65 according to the system and method described herein in order to confirm the beverage brand. At step 66, a jingle and a video advertisement are played for the beverage brand selected at step 64. The beverage dispensing system 1 then begins dispensing the beverage selection at step 67. At step 68, it is determined (such as by the computer system 36 and/or controller 32) whether the beverage dispensing process is complete. If the beverage dispensing process is not complete, then the system continues to play the jingle and video at step 69 until the system determines that the dispensing process is complete. Once it is determined that dispensing is completed, the system continues to step 70, where it determines whether the jingle and video are at an acceptable stopping point at step 70. For example, relevant software executed on the processor 30 may have designated stopping locations for a song and/or video, rather than stopping mid-tune or mid-message. If it is determined that the jingle and/or video are not at a designated stopping point, the system may continue to play the jingle and/or video at step 71 until such a stop point is reached, at which point the dispensing process may terminate at step 72.

In the present disclosure, certain terms have been used for brevity, clearness and understanding. No unnecessary limitations are to be implied therefrom beyond the requirement of the prior art because such terms are used for descriptive purposes only and are intended to be broadly construed. The different systems and methods described herein may be used alone or in combination with other systems and devices. Various equivalents, alternatives and modifications are possible within the scope of the appended claims.

What is claimed is:

1. A beverage dispensing system comprising:
a user interface system having a digital display, the user interface system configured to receive a beverage selection from a user;
a beverage dispenser having a plurality of beverage sources, the beverage dispenser operable to control a flow of beverage from one or more of the beverage sources in accordance with the beverage selection; and
a surface electroacoustic transducer attached to a portion of the digital display or the beverage dispenser that, in response to receiving the beverage selection, conducts vibrations into the portion of the digital display or the beverage dispenser to produce a sound from that portion.

2. The beverage dispensing system of claim 1, wherein the surface electroacoustic transducer is attached to a front of the digital display such that the sound is produced by the front toward the user.

3. The beverage dispensing system of claim 2, wherein the front is glass and the surface electroacoustic transducer is attached to an inside top portion of the glass front.

4. The beverage dispensing system of claim 1, wherein the surface electroacoustic transducer is attached to a metal frame of the digital display such that the sound is produced by the metal frame.

5. The beverage dispensing system of claim 1, wherein the surface electroacoustic transducer is attached to an ice dispenser in the beverage dispenser such that the sound is produced by the ice dispenser.

6. The beverage dispensing system of claim 1, wherein the beverage selection includes a beverage size and a beverage brand, and wherein the sound confirms the beverage size and/or the beverage brand.

7. The beverage dispensing system of claim 1, wherein the sound corresponds with a beverage brand of the beverage selection.

8. The beverage dispensing system of claim 7, wherein the sound includes a jingle for the beverage brand.

9. The beverage dispensing system of claim 1, wherein the sound includes an instruction to the user.

10. The beverage dispensing system of claim 1, wherein, in response to receiving the beverage selection, the digital display plays a video advertisement and the sound corresponds with the video advertisement.

11. The beverage dispensing system of claim 1, wherein the sound is produced for a length of time to dispense the beverage selection.

12. A user interface system for a beverage dispensing system, the user interface system comprising:
a digital display that displays one or more beverage options, the digital display having a front;
a user input receiver for receiving user input of a beverage selection; and
a surface electroacoustic transducer attached to a portion of the digital display that, in response to receiving the beverage selection, conducts vibrations into the portion of the digital display to produce a sound from the portion.

13. The user interface system of claim 12, wherein the surface electroacoustic transducer is attached to a front of the digital display such that the sound is produced by the front toward the user.

14. The user interface system of claim 13, wherein the front of the digital display is comprised of glass and the surface electroacoustic transducer is attached to an inside top portion of the glass front.

15. The user interface system of claim 12, wherein the surface electroacoustic transducer is attached to a metal frame of the digital display such that the sound is produced by the metal frame.

16. A method of dispensing a beverage, the method comprising:
receiving a beverage selection at a user interface system that includes a digital display, the digital display having a front;
operating a surface electroacoustic transducer attached to the front of the digital display to conduct vibrations into the front of the digital display to produce a sound from the front of the digital display in response to receiving the beverage selection; and
dispensing a beverage component from one or more beverage sources in accordance with the beverage selection.

17. The method of claim 16, wherein the sound is produced for a length of time to dispense the beverage selection.

18. The method of claim 16, wherein the step of receiving a beverage selection includes receiving a beverage size and a beverage brand, and wherein the sound confirms the beverage size and/or the beverage brand.

19. The method of claim 16, wherein the sound includes a jingle for a beverage brand.

20. The method of claim 16, wherein the surface electroacoustic transducer is attached to the front of the digital display or a metal frame in contact with the front of the digital display.
